(19) United States
(12) Patent Application Publication
(10) Pub. No.: US 2025/0365821 A1
(43) Pub. Date: Nov. 27, 2025

(54) HEATING AND THERMAL INSULATION APPARATUS

(71) Applicant: Kai Zhong, Hangzhou (CN)

(72) Inventor: Kai Zhong, Hangzhou (CN)

(21) Appl. No.: 19/289,002

(22) Filed: Aug. 2, 2025

(30) Foreign Application Priority Data
Jul. 21, 2025 (CN) 202521517546.4

(51) Int. Cl. H05B 3/28

(52) U.S. Cl. CPC H05B 3/28

(57) ABSTRACT

A heating and thermal insulation apparatus is provided. The heating and thermal insulation apparatus includes a power supply component and a heating wire electrically connected to the power supply component. The heating and thermal insulation apparatus further includes a heating body. The heating body includes a heating contact surface located at the top and a placement surface located at the bottom. A heat source layer is formed between the heating contact surface and the placement surface. A working part of the heating wire is located on the heat source layer and is tightly wrapped by the heat source layer. The heating wire in the present disclosure is not prone to be offset in position, thereby ensuring a subsequent heating and thermal insulation effect, prolonging a service life of the heating and thermal insulation apparatus, and improving user experience.

### TECHNICAL FIELD

The present disclosure relates to a heating and thermal insulation apparatus.

### BACKGROUND

An existing heating and thermal insulation apparatus is a food ingredient thermal insulation table, a heating plate, or the like. Heating is generally implemented by using a heating wire embedded in a housing, but an existing heating wire is generally located in a preset embedded slot. A shape of a slot body is adapted by glue injection or buckling to implement heating wire fastening.

However, there is still a lack of structural stability by setting the embedded slot in the housing. In a case that injected glue falls off or assembly is not in place, the heating wire is prone to fall off due to movement of the food ingredient thermal insulation table or the heating plate. Especially, when the foregoing structure is applied to a flexible thermal insulation apparatus, in a process that the flexible thermal insulation apparatus is repeatedly folded or rolled up, the heating wire is prone to be offset in position, so that a subsequent heating effect is affected, and a service life of the heating and thermal insulation apparatus is affected.

### SUMMARY

To overcome the disadvantages in the prior art, the present disclosure provides a heating and thermal insulation apparatus.

The technical solution adopted for solving the technical problem of the present disclosure is as follows.

The present disclosure provides a heating and thermal insulation apparatus. The heating and thermal insulation apparatus includes a power supply component and a heating wire electrically connected to the power supply component. The heating and thermal insulation apparatus further includes a heating body. The heating body includes a heating contact surface located at the top and a placement surface located at the bottom. A heat source layer is formed between the heating contact surface and the placement surface. A working part of the heating wire is located on the heat source layer and is tightly wrapped by the heat source layer.

The heat source layer is an implant layer, and the heating wire is in close contact with the heat source layer.

The heat source layer is an elastic pouring layer.

The heating contact surface, the placement surface and the heat source layer are made of a flexible material.

The heating and thermal insulation apparatus includes a flexible top plate. The heating contact surface is formed on an upper surface of the flexible top plate. The heat source layer is located inside the flexible top plate. The placement surface is formed inside the heat source layer.

The flexible top plate includes an annular outer wall corresponding to a contour of the heat source layer, and the annular outer wall is sleeved on a periphery of the heat source layer.

The flexible top plate is integrally formed, and the flexible top plate is made of silica gel, PE (Polyethylene), TPE (Thermoplastic Elastomer) or PLA (Polylactic Acid).

The heating and thermal insulation apparatus includes a flexible bottom plate. The placement surface is formed at the bottom of the flexible bottom plate. The heat source layer is located above the flexible bottom plate. The heating contact surface is formed on the top of the heat source layer.

The flexible bottom plate is integrally formed, and the flexible bottom plate is made of silica gel, PE, TPE or PLA.

The placement surface includes a placement surface body located at the bottom of the heating body, and a plurality of support bulges protruding downward from the placement surface body. A heat dissipation channel is formed between the support bulges.

The support bulge includes a bulge body, and further includes a support transition part extending slantly and upward from the bottom of the bulge body. The top of the support transition part extends to the placement surface body.

The bulge body has an elliptical cross-section shape. A shape of the support transition part corresponds to that of the bulge body. The support transition part includes a long end corresponding to a long axis of the elliptical bulge body, and further includes a short end corresponding to a short axis of the elliptical bulge body.

The heating and thermal insulation apparatus includes an insulation housing configured to place the power supply component. A leg is formed at the bottom of the insulation housing. The bottom of the leg and the bottom of the bulge body are located on a same horizontal plane.

The heating wire further includes a connecting part extending from the heat source layer to the power supply component. The connecting part includes a first end and a second end. A working part of the heating wire includes a line-shaped section and a U-shaped circuiting section that are connected. The line-shaped section is connected to the first end of the connecting part, and the U-shaped circuiting section is connected to the second end of the connecting part.

The heating body has a thickness of smaller than 5 cm, and a laying area of the working part of the heating wire is greater than 60% of a surface area of the heating body.

The insulation housing includes an upper housing and a lower housing, and an opening into that a side edge of the heating body stretches is formed between the upper housing and the lower housing.

The insulation housing is disposed at a short side of the heating body, and the short side of the heating body stretches into the opening.

A notch is formed at the short side, and the first end and the second end of the connecting part stretch out of the notch.

A plurality of first through holes are formed in an edge that is of the heating body and that corresponds to the notch. Positioning columns are formed at corresponding positions of the first through holes in the upper housing. Second through holes are formed at corresponding positions of the positioning columns in the lower housing.

The support bulge is a U-shaped stand column.

The embodiments of the present disclosure have the following beneficial effects.

Embodiments of the present disclosure provide a heating and thermal insulation apparatus. The heating and thermal insulation apparatus includes a power supply component and a heating wire electrically connected to the power supply component. The heating and thermal insulation apparatus further includes a heating body. The heating body includes a heating contact surface located at the top and a placement surface located at the bottom. A heat source layer is formed between the heating contact surface and the placement surface. A working part of the heating wire is located on the heat source layer and is tightly wrapped by the heat source layer. For example, the heat source layer may be an elastic pouring layer or an implant layer. The heating wire may be poured simultaneously with the heat source layer or buried in the heat source layer in an implanted manner, so as to implement close contact between the heating wire and the heat source layer. The heating wire is not prone to fall off due to movement of the heating and thermal insulation apparatus. Especially, when a flexible thermal insulation apparatus is applied, in a process that the flexible thermal insulation apparatus is repeatedly folded or rolled up, the heating wire is also not prone to be offset in position, so that a subsequent heating effect is ensured, a service life of the heating and thermal insulation apparatus is prolonged, and user experience is improved.

### BRIEF DESCRIPTION OF THE DRAWINGS

To describe the technical schemes in the embodiments of the present discourse more clearly, the following briefly describes the accompanying drawings required for describing the embodiments. The accompanying drawings in the following description show merely some embodiments of the present disclosure, and a person of ordinary skill in the art may derive others drawings from these accompanying drawings without creative efforts.

The present disclosure is further described in conjunction with the accompanying drawings and embodiments.

FIG. 1 is a space diagram of an overlooking view of a heating and thermal insulation apparatus according to a first embodiment of the present disclosure;

FIG. 2 is an exploded view after an insulation housing and a heating body are split in FIG. 1;

FIG. 3 is an exploded view after further splitting in FIG. 2, where a heating wire and a heat source layer are also split;

FIG. 4 is a space diagram of an upward view in FIG. 1;

FIG. 5 is a space diagram of a heating wire according to a first embodiment of the present disclosure;

FIG. 6 is a space diagram of an insulation housing according to a first embodiment of the present disclosure; and

FIG. 7 is an enlarged view of part A in FIG. 4.

Reference signs in the accompanying drawings: 1: heating wire; 11: working part; 111: line-shaped section; 112: U-shaped circuiting section; 12: connecting part; 121: first end; 122: second end; 2: power supply component; 3: heating body; 31: heating contact surface; 32: placement surface; 321: placement surface body; 322: support bulge; 3221: bulge body; 3222: support transition part; 3222a: long end; 3222b: short end; 33: heat source layer; 34: flexible top plate; 341: annular outer wall; 35: notch; 36: first through hole; 4: insulation housing; 41: leg; 42: upper housing; 421: positioning column; 43: lower housing; 431: second through hole; and 44: opening.

### DETAILED DESCRIPTION OF THE EMBODIMENTS

In order to make the technical problem to the be solved, the technical solution and the beneficial effects clearer, the present disclosure is further described in detail in combination with the accompanying drawings and the embodiments. It shall be understood that, the embodiments described herein are only intended to illustrate but not to limit the present disclosure.

When an embodiment of the present disclosure refers to ordinal numerals such as “first” and “second”, it should be understood that, unless the order is actually expressed in the context, it is merely intended for differentiation.

In the description of the present disclosure, it needs to be illustrated that, except as otherwise noted, the terms such as install”, “link” and “connect” should be generally understood, for example, the components can be fixedly connected, and also can be detachably connected or integrally connected; the components can be mechanically connected, and also can be electrically connected; the components can be directly connected and also can be indirectly connected through an intermediate, and two components can be communicated internally. For those skilled in the art, the specific meanings of the terms in the present disclosure can be understood according to specific conditions.

### Embodiment 1

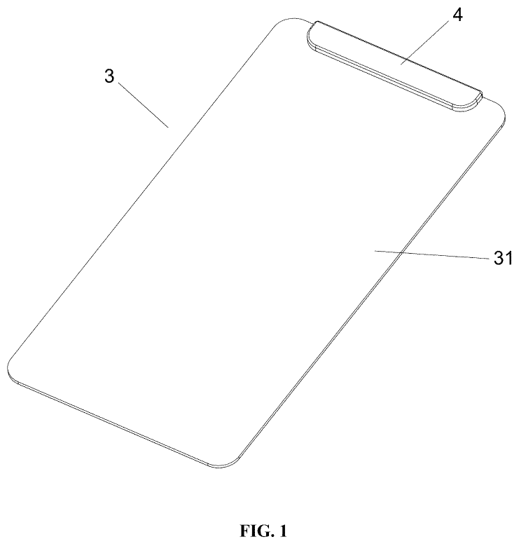

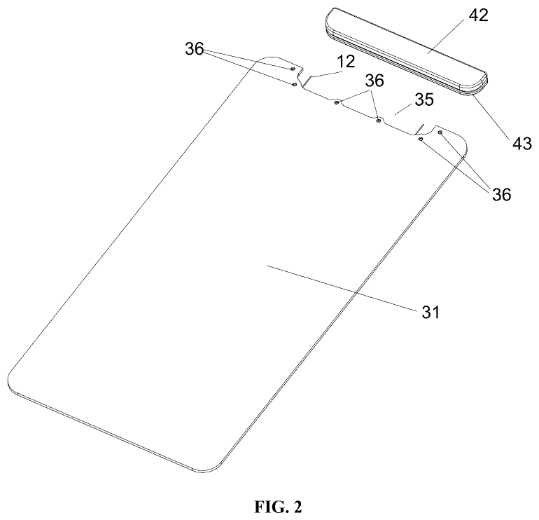

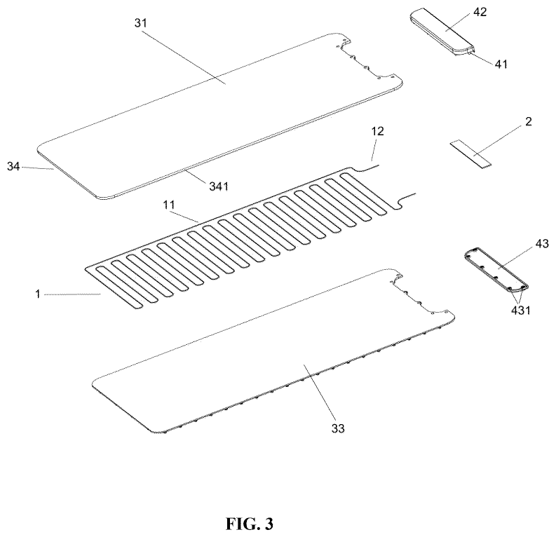

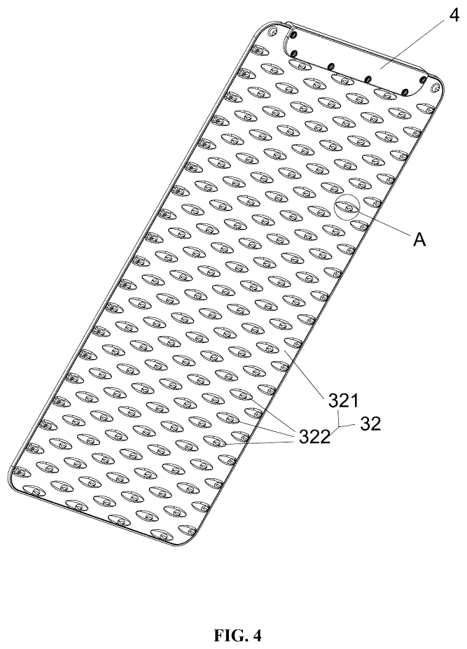

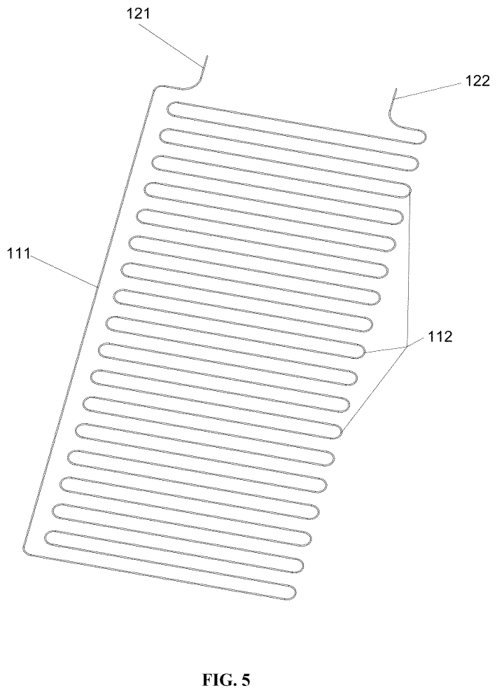

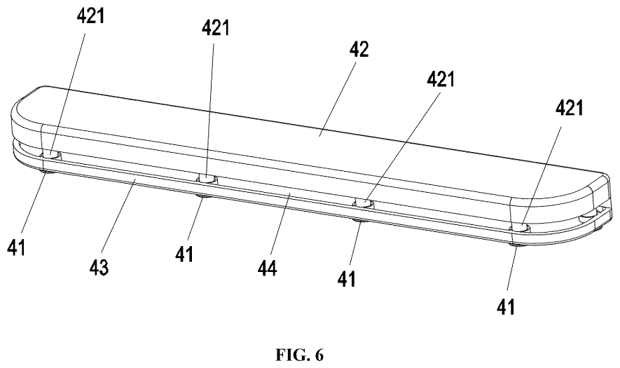

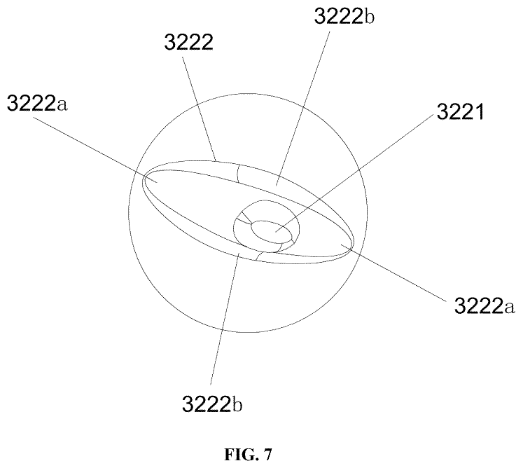

Referring to FIG. 1 to FIG. 7, the embodiment provides a heating and thermal insulation apparatus. The heating and thermal insulation apparatus includes a power supply component 2 and a heating wire 1 electrically connected to the power supply component 2. The heating and thermal insulation apparatus further includes a heating body 3. The heating body 3 includes a heating contact surface 31 located at the top and a placement surface 32 located at the bottom. A heat source layer 33 is formed between the heating contact surface 31 and the placement surface 32. A working part 11 of the heating wire 1 is located on the heat source layer and is tightly wrapped by the heat source layer 33.

In the embodiment, the heat source layer 33 is an elastic pouring layer. For example, the heat source layer 33 may be silicone rubber, PE, TPE, or PLA, and is silicone rubber in the embodiment. By pouring silicone rubber in the heating wire 1, the heating wire 1 in the elastic pouring layer is in close contact with the silicone rubber part, so that a situation of position offset is not prone to occur.

The heating contact surface 31, the placement surface 32 and the heat source layer are at least made of a flexible material. As a preferred solution rather than a limitation, all materials of the heating body 3 in the embodiment are flexible materials, where the heating wire 1 includes an electric wire and an insulation material that wraps the electric wire.

In the embodiment, the heating and thermal insulation apparatus includes a flexible top plate 34. The heating contact surface 31 is formed on an upper surface of the flexible top plate 34. The heat source layer 33 is located below the flexible top plate 34. The placement surface 32 is formed at the bottom of the heat source layer 33. Specifically, the heat source layer 33 in the embodiment may be used as a flexible bottom plate of the heating and thermal insulation apparatus.

As a preferred solution rather than a limitation, the flexible top plate 34 in the embodiment includes an annular outer wall 341 corresponding to a contour of the heat source layer 33, and the annular outer wall 341 is sleeved on a periphery of the heat source layer 33. Thus, the periphery of the heat source layer 33 as the flexible bottom plate is wrapped by the annular outer wall 341. The flexible top plate 34 in the embodiment is integrally formed, so the heating and thermal insulation apparatus in the embodiment is higher in structural stability. In addition, when the heating and thermal insulation apparatus in the embodiment is placed on a table in a forward direction, from a perspective of a user, only the flexible top plate 34 is exposed out of the heating body 3 as a whole, thereby improving an integrated effect of the heating and thermal insulation apparatus in the embodiment of the present disclosure, and improving using experience of the user. The flexible top plate 34 is made of silica gel, PE, TPE or PLA.

As a specific solution rather than a limitation, the placement surface 32 includes a placement surface body 321 located at the bottom of the heating body 3, and a plurality of support bulges 322 protruding downward from the placement surface body 321. A heat dissipation channel is formed between the support bulges 322. In the embodiment, the heating body 3 is raised by the support bulge 322, so that a heat dissipation channel is formed between the support bulge 322 below the heating body 3, thereby facilitating heat dissipation at the bottom of the heating and thermal insulation apparatus and improving product stability.

In some embodiments, the support bulge 322 and the bulge body 3 may be integrally formed and made of a same material. For example, the support bulge 322 may be a U-shaped stand column. Preferably, in the embodiment, the support bulge 322 includes a bulge body 3221, and further includes a support transition part 3222 extending slantly and upward from the bottom of the bulge body 3221. The top of the support transition part 3222 extends to the placement surface body 321.

Further, the bulge body 3221 has an elliptical cross-section shape. A shape of the support transition part 3222 corresponds to that of the bulge body 3221. The support transition part includes a long end 3222a corresponding to a long axis of the elliptical bulge body 3221, and further includes a short end 3222b corresponding to a short axis of the elliptical bulge body 3221. The support transition part 3222 in the embodiment increases a contact area between the support bulge 322 and the placement surface body 321, so that the support bulge 322 may have a good effect of supporting the heating body 3. When a to-be-heated object is placed on the heating body 3, a situation of deformation or collapse caused by the fact that there is a lack of support at a partial position of the heating body 3 cannot occur, thereby improving product stability.

The to-be-heated object in the embodiment includes, but is not limited to, a meal, tea, and food ingredients. For example, the heating and thermal insulation apparatus in the embodiment may be further configured to dry clothes, thaw food ingredients, heat a facial mask, and the like.

As a specific solution rather than a limitation, the heating and thermal insulation apparatus includes an insulation housing 4 configured to place the power supply component 2. A leg 41 is formed at the bottom of the insulation housing 4. The bottom of the leg 41 and the bottom of the bulge body 3221 are located on a same horizontal plane. The bottom of the leg 41 and the bottom of the bulge body 3221 are located on the same horizontal plane, so that the insulation housing 4 is effectively supported, and the structural stability of the heating and thermal insulation apparatus is further improved.

As a specific solution rather than a limitation, the heating wire 1 further includes a connecting part 12 extending from the heat source layer 33 to the power supply component 2. The connecting part 12 includes a first end 121 and a second end 122. A working part 11 of the heating wire includes a line-shaped section 111 and a U-shaped circuiting section 112 that are connected. The line-shaped section 111 is connected to the first end 121 of the connecting part 12, and the U-shaped circuiting section 112 is connected to the second end 122 of the connecting part 12.

As a specific solution rather than a limitation, the heating body 3 has a thickness of smaller than 5 cm, and a laying area of the working part 11 of the heating wire 1 is greater than 60% of a surface area of the heating body 3. Preferably, the thickness of the heating body 3 in the embodiment is a sum of a thickness of the flexible top plate 34 and a thickness of the placement surface 32. The heating body 3 has a thickness of about 2-3 cm. The paving area of the working part 11 of the heating wire 1 is greater than 80% of the surface area of the heating body 3.

As a specific solution rather than a limitation, the insulation housing 4 includes an upper housing 42 and a lower housing 43, and an opening 44 into that a side edge of the heating body 3 stretches is formed between the upper housing 42 and the lower housing 43. The insulation housing 4 is disposed at a short side of the heating body 3, and the short side of the heating body 3 stretches into the opening 44. By providing the short side of the opening 44 to stretch into the heating body 3, a combination of the heating body 3 and the insulation housing 4 is closer while a good integrated effect is ensured.

In the embodiment, a notch 35 is formed at the short side, and the first end 121 and the second end 122 of the connecting part 12 stretch out of the notch 35 and enter into the insulation housing 4 to be electrically connected to the power supply component 2.

In order to further strengthen the structural stability of the heating and thermal insulation apparatus, a plurality of first through holes 36 are formed in an edge that is of the heating body 3 and that corresponds to the notch 35. Positioning columns 421 are formed at corresponding positions of the first through holes 36 in the upper housing 42. Second through holes 431 are formed at corresponding positions of the positioning columns 422 in the lower housing 43.

A heat-sensitive color change layer is further disposed on a surface of the heating contact surface. The user may intuitively observe a pattern range and a depth of the heat-sensitive color change layer, which determines a temperature and a radiation range of the heating body 3, and provides an intuitive indication for the user to perform a heating/thermal insulation operation.

As a preferred solution rather than a limitation, the power supply component 2 in the embodiment further includes a control module. The control module is configured to control a temperature gear of the heating body 3 and provide a timing switch function. The heating and thermal insulation apparatus in the embodiment has functions of a constant temperature and timing turning-on and turning-off.

The embodiment of the present disclosure provides a heating and thermal insulation apparatus. The heating and thermal insulation apparatus includes a power supply component and a heating wire electrically connected to the power supply component. The heating and thermal insulation apparatus further includes a heating body. The heating body includes a heating contact surface located at the top and a placement surface located at the bottom. A heat source layer is formed between the heating contact surface and the placement surface. A working part of the heating wire is located on the heat source layer and is tightly wrapped by the heat source layer. For example, the heat source layer may be an elastic pouring layer or an implant layer. The heating wire may be poured simultaneously with the heat source layer or buried in the heat source layer in an implanted manner, so as to implement close contact between the heating wire and the heat source layer. The heating wire is not prone to fall off due to movement of the heating and thermal insulation apparatus. Especially, when a flexible thermal insulation apparatus is applied, in a process that the flexible thermal insulation apparatus is repeatedly folded or rolled up, the heating wire is also not prone to be offset in position, so that a subsequent heating effect is ensured, a service life of the heating and thermal insulation apparatus is prolonged, and user experience is improved.

### Embodiment 2

The embodiment provides a heating and thermal insulation apparatus. Different from the foregoing first embodiment, a heat source layer in the embodiment is an implant layer, and a heating wire is implanted into the heat source layer, so as to implement close contact between the heating wire and the heat source layer.

In addition, the heating and thermal insulation apparatus in the embodiment includes a flexible bottom plate. The placement surface is formed at the bottom of the flexible bottom plate. The heat source layer is located above the flexible bottom plate. The heating contact surface is formed on the top of the heat source layer. Specifically, the heat source layer in the embodiment may be used as a flexible bottom plate of the heating and thermal insulation apparatus. The flexible bottom plate in the embodiment is integrally formed, and the flexible bottom plate is made of silica gel, PE, TPE or PLA.

### Embodiment 3

The embodiment provides a heating and thermal insulation apparatus. Different from the foregoing first embodiment, the heating and thermal insulation apparatus in the embodiment further includes a flexible bottom plate. The heat source layer is located between the flexible top plate and the flexible bottom plate. The heat source layer may be connected to the flexible top plate and the flexible bottom plate in a hot melting manner.

As described above, one or more embodiments are provided in combination with concrete content, and the specific implementation of the present disclosure is not intended to be limited to these descriptions. Approximate and similar methods and structures in the present disclosure, or a plurality of technical deductions and substitutions can be made without departing from the concept of the present disclosure, and should be regarded as the scope of protection of the present disclosure.

What is claimed is:

1. A heating and thermal insulation apparatus, comprising a power supply component and a heating wire electrically connected to the power supply component; wherein the heating and thermal insulation apparatus further comprises a heating body, the heating body comprises a heating contact surface located at the top and a placement surface located at the bottom, a heat source layer is formed between the heating contact surface and the placement surface, and a working part of the heating wire is located on the heat source layer and is tightly wrapped by the heat source layer.

2. The heating and thermal insulation apparatus according to claim 1, wherein the heat source layer is an implant layer, and the heating wire is in close contact with the heat source layer.

3. The heating and thermal insulation apparatus according to claim 1, wherein the heat source layer is an elastic pouring layer.

4. The heating and thermal insulation apparatus according to claim 2, wherein the heating contact surface, the placement surface and the heat source layer are made of a flexible material.

5. The heating and thermal insulation apparatus according to claim 4, comprising a flexible top plate, wherein the heating contact surface is formed on an upper surface of the flexible top plate, the heat source layer is located inside the flexible top plate, and the placement surface is formed inside the heat source layer.

6. The heating and thermal insulation apparatus according to claim 5, wherein the flexible top plate comprises an annular outer wall corresponding to a contour of the heat source layer, and the annular outer wall is sleeved on a periphery of the heat source layer.

7. The heating and thermal insulation apparatus according to claim 6, wherein the flexible top plate is integrally formed, and the flexible top plate is made of silica gel, PE (Polyethylene), TPE (Thermoplastic Elastomer) or PLA (Polylactic Acid).

8. The heating and thermal insulation apparatus according to claim 4, comprising a flexible bottom plate, wherein the placement surface is formed at the bottom of the flexible bottom plate, the heat source layer is located above the flexible bottom plate, and the heating contact surface is formed on the top of the heat source layer.

9. The heating and thermal insulation apparatus according to claim 8, wherein the flexible bottom plate is integrally formed, and the flexible bottom plate is made of silica gel, PE, TPE or PLA.

10. The heating and thermal insulation apparatus according to claim 4, wherein the placement surface comprises a placement surface body located at the bottom of the heating body, a plurality of support bulges protruding downward from the placement surface body, and a heat dissipation channel is formed between the support bulges.

11. The heating and thermal insulation apparatus according to claim 10, wherein the support bulge comprises a bulge body, and further comprises a support transition part extending slantly and upward from the bottom of the bulge body, and the top of the support transition part extends to the placement surface body.

12. The heating and thermal insulation apparatus according to claim 11, wherein the bulge body has an elliptical cross-section shape, a shape of the support transition part corresponds to that of the bulge body, and the support transition part comprises a long end corresponding to a long axis of the elliptical bulge body, and further comprises a short end corresponding to a short axis of the elliptical bulge body.

13. The heating and thermal insulation apparatus according to claim 12, wherein the heating and thermal insulation apparatus comprises an insulation housing configured to place the power supply component, a leg is formed at the bottom of the insulation housing, and the bottom of the leg and the bottom of the bulge body are located on a same horizontal plane.

14. The heating and thermal insulation apparatus according to claim 13, wherein the heating wire further comprises a connecting part extending from the heat source layer to the power supply component, the connecting part comprises a first end and a second end, a working part of the heating wire comprises a line-shaped section and a U-shaped circuiting section that are connected, the line-shaped section is connected to the first end of the connecting part, and the U-shaped circuiting section is connected to the second end of the connecting part.

15. The heating and thermal insulation apparatus according to claim 14, wherein the heating body has a thickness of smaller than 5 cm, and a laying area of the working part of the heating wire is greater than 60% of a surface area of the heating body.

16. The heating and thermal insulation apparatus according to claim 15, wherein the insulation housing comprises an upper housing and a lower housing, and an opening into that a side edge of the heating body stretches is formed between the upper housing and the lower housing.

17. The heating and thermal insulation apparatus according to claim 16, wherein the insulation housing is disposed at a short side of the heating body, and the short side of the heating body stretches into the opening.

18. The heating and thermal insulation apparatus according to claim 17, wherein a notch is formed at the short side, and the first end and the second end of the connecting part stretch out of the notch.

19. The heating and thermal insulation apparatus according to claim 18, wherein a plurality of first through holes are formed in an edge that is of the heating body and that corresponds to the notch, positioning columns are formed at corresponding positions of the first through holes in the upper housing, and second through holes are formed at corresponding positions of the positioning columns in the lower housing.

20. The heating and thermal insulation apparatus according to claim 10, wherein the support bulge is a U-shaped stand column.
